(19) United States
(12) Patent Application Publication
(10) Pub. No.: US 2020/0048906 A1
(43) Pub. Date: Feb. 13, 2020

(54) COMPOSITE WOOD ARRANGEMENT AND METHOD FOR MANUFACTURING SAID ARRANGEMENT

(71) Applicant: Aalto Haitek Oy, Toholampi (FI)

(72) Inventor: Tapani Samuel Honkala, Toholampi (FI)

(21) Appl. No.: 16/488,888

(22) PCT Filed: Feb. 21, 2018
(86) PCT No.: PCT/FI2018/050128

§ 371 Date: Aug. 26, 2019

(30) Foreign Application Priority Data
Feb. 27, 2017 (FI) U20174052
Mar. 31, 2017 (FI) U20174092
Aug. 25, 2017 (FI) U20174200

(51) Int. Cl. E04C 3/14; E04B 2/70; E04C 2/14; E04C 2/40; B27M 3/00; B32B 21/04; B32B 3/06

(52) U.S. Cl. CPC E04C 3/14; E04B 2/702; E04C 2/14; E04C 2/40; E04C 2/46; B32B 21/042; B32B 3/06; E04B 2103/04; B27M 3/0046

(57) ABSTRACT

The present invention relates to a composite wood arrangement comprising construction components (1) mechanically joined together in a parallel position. Such a construction component comprises at least one profiled side surface (2, 3) and, connecting them together, at least one edge surface (4, 5) and end surfaces (6, 7), perpendicular to the longitudinal axis (11) of the construction component. In the invention, the side surfaces in parallel construction components are adapted in an opposite position in pairs so that profile crests (8) and throughs (9) in opposite side surfaces are substantially parallel. There are these construction components (1) adapted successively in their longitudinal direction and adjacently in at least the lateral direction of the composite wood arrangement to establish a uniform plate-like structure, whereby the construction components are joined together by mechanical joining means.

### BACKGROUND OF THE INVENTION

The present invention relates to a composite wood arrangement in accordance with the preamble of claim 1.

The invention also relates to a method as claimed in the preamble of claim 10 for manufacturing such a composite wood arrangement.

Such an arrangement may be utilized for most diverse purposes in which the need exists to manufacture essentially solid wooden structures.

As a result, in recent times the manufacture has started of wooden residential buildings, in particular, by using solid wood CLT (Cross Laminated Timber) panels. The building physical functioning of such a wooden panel has not been very much examined in the Finnish conditions, for example, and the concern has arisen that the durability of the panel is not what is desired due to its manufacturing method.

### SUMMARY OF THE INVENTION

It is the purpose of the present invention to establish an alternative solution for the prior art construction material, which would not have problems associated with it.

This object is achieved in such a manner that the composite wood arrangement is, in accordance with the present invention, provided with the characteristic features defined in the claims. The present problems may be solved, in particular, by combining in the arrangement the characteristics as disclosed in the characterizing part of claim 1. On the other hand, the problems insofar as the method is concerned may be solved by combining the characteristics as disclosed in the characterizing part of claim 10.

Preferred embodiments of the invention are disclosed in the dependent claims.

The invention provides considerable advantages. The present solution thus accomplishes, with simple structural solutions and methods, remarkably economical buildings as to their thermal economy. The composite wood arrangement according to the invention may also be implemented with construction components that are very inexpensive to manufacture. The joining together of the construction components is simple and does not require any specif special skills let alone special tools. Because mechanical joining means, only, are used in the work, that is, construction components are joined together with the aid of shape, material strips, tie rods, joining cables, screws or rods, the final structure may be accomplished without chemicals.

The wooden construction components used in manufacturing a composite wood arrangements may even be so dimensioned that they may be stored on normal, standardized pallets and moved to the final assembly site by using conventional transport means.

As a result of the large carrying capacity and rigid structure, the inventive composite wood arrangement and method are additionally suitable for the implementation of residential or similar buildings. This allows a composite wood arrangement to be used for manufacturing various solid wood structures, which may include base floor and intermediate floor structures of said residential, business or other facilities and/or their exterior wall or partition wall structures. In addition to these, a composite wood arrangement is also suitable for building bridges, their support structures, and formwork used at bridge building sites. The inventive composite wood arrangement is excellently suited for the implementation of various special structures, such as sports stadiums or velodromes, for example.

Due to the present composite wood arrangement using flexible joining methods and solutions, the structures made of it are excellent for earthquake-prone environments.

Other advantages provided by the invention are disclosed in the following more detailed description of specific embodiments of the invention.

### BRIEF DESCRIPTION OF THE FIGURES

In the following, some preferred embodiments of the invention will be explained in more detail and with reference to the accompanying drawing, in which

FIG. 1 schematically shows the various embodiments A, B, C, and D of a construction component used in establishing a composite wood arrangement,

FIG. 2 shows a schematic cross-section of the construction component according to FIG. 1,

FIG. 3 is a schematic side view showing the construction component according to FIG. 1.

FIG. 4 shows a first alternative embodiment of the construction component,

FIG. 5 shows a second alternative embodiment of the construction component,

FIG. 6 shows a third alternative embodiment of the construction component,

FIG. 7 shows a fourth alternative embodiment of the construction component,

FIG. 8 shows a fifth alternative embodiment of the construction component,

FIG. 9 shows a sixth alternative embodiment of the construction component,

FIG. 10 shows a first alternative joining method of the construction components,

FIG. 11 shows a second alternative joining method of the construction components,

FIG. 12 shows a third alternative joining method of the construction components,

FIG. 13 is a first embodiment of the composite wood arrangement,

FIG. 14 is a second embodiment of the composite wood arrangement,

FIG. 15 is a third embodiment of the composite wood arrangement,

FIG. 16 is a fourth embodiment of the composite wood arrangement,

FIG. 17 is a fifth embodiment of the composite wood arrangement,

FIG. 18 is a sixth embodiment of the composite wood arrangement,

FIG. 19 is a schematic representation of how the structure thickness of the composite wood arrangement according to the second embodiment of FIG. 14 may be deepened by installing construction components adjacently by their side surfaces,

FIG. 20 is a schematic representation of how the structure thickness of the composite wood arrangement according to the third embodiment of FIG. 15 may be deepened by installing construction components adjacently by their side surfaces,

FIG. 21 is a schematic representation of how the structure thickness of the composite wood arrangement according to the fifth embodiment of FIG. 17 may be deepened by installing construction components adjacently by their side surfaces,

FIG. 22 shows other joining methods of construction components to achieve a composite wood arrangement,

FIG. 23 shows an object for utilizing the inventive composite wood arrangement,

FIG. 24 is a top view of the schematic structure of the composite wood arrangement,

FIG. 25 is a schematic cross section of an embodiment of the composite wood arrangement,

FIG. 26 is a detail view of an extension alternative of a drawbar used in the embodiment of FIG. 25 when construction components are being joined, and

FIG. 27 shows a detail view of joining construction component groups together.

### DETAILED DESCRIPTION OF PREFERRED EMBODIMENTS

The present figures do not show the composite wood arrangement in scale but the figures are schematic, illustrating the general structure and operation of the preferred embodiments. The construction components shown by reference numbers in the attached figures then correspond to the construction components marked by reference numbers in this specification.

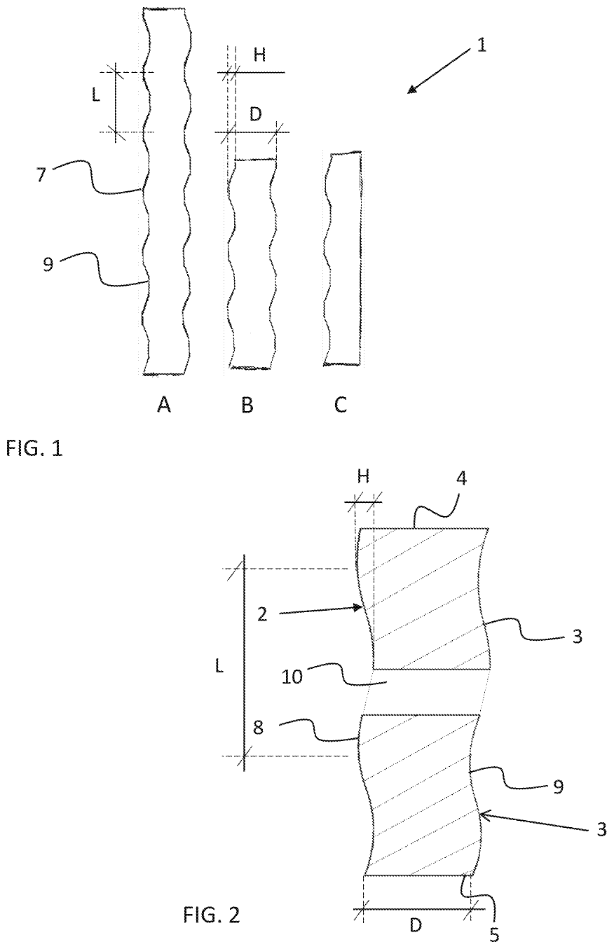

The present composite wood arrangement is formed by using the exemplary construction components 1 of FIGS. 1 to 3. These advantageously comprise construction components made of wood, whereby FIG. 1 shows advantageous structures A, B and C of the construction component. The construction components then comprise parts made of either raw wood or wood refined by methods known per se, such as heat-treating or pressure treating.

Although the following will discuss the construction component as a wooden construction part, in particular, it may also be manufactured of plastic, metal, or wood composite, for example. Compared to these other raw material, wood, however, makes it possible to manufacture a naturally breathing structure of the type of a log structure.

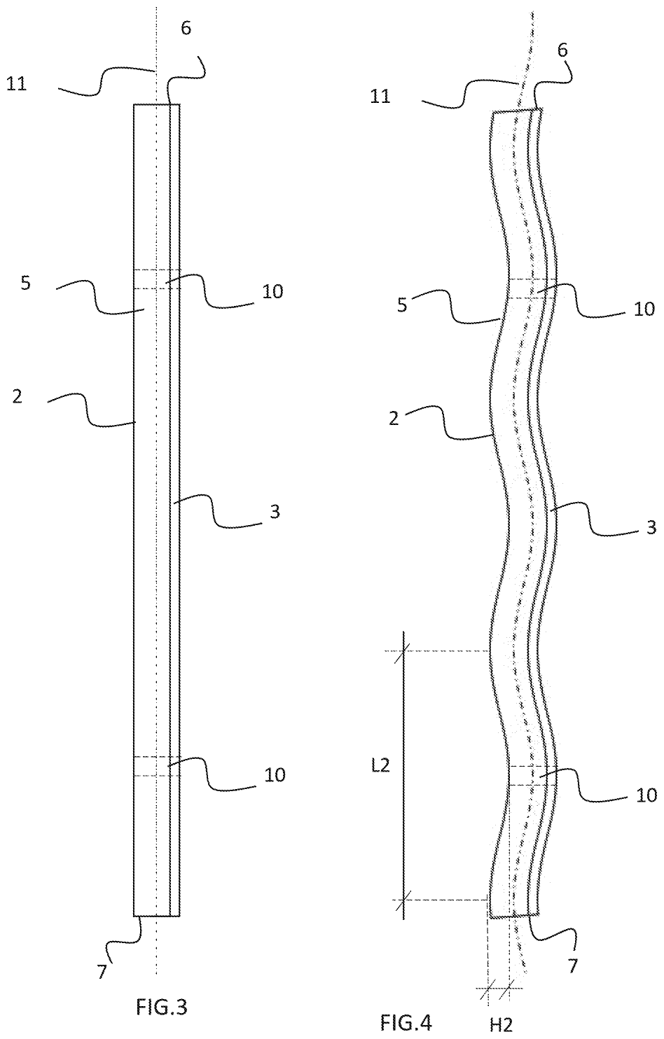

Each construction component of FIG. 1 has at least one profiled side surface 2 and 3 that are connected, as shown in FIG. 2, by edge surfaces 4 and 5 as well as end surfaces 6 and 7 visible in FIG. 3. As may be seen in FIGS. 1 and 2, for example, the side surfaces of the two embodiments, A and B, of the construction component 1 have been formed substantially symmetrically parallel. The shape of the wooden construction component has in this case been accomplished by using a machining method known per se, such as milling or planing. If the construction component is made of other material than wood, its shape may also be accomplished by casting, pressing, or 3D printing, for instance.

The edge and end surfaces 4 to 7 of the construction component are advantageously substantially even in the embodiment of FIGS. 1, 2 and 3, whereby on the one hand the edge surfaces and on the other hand the end surfaces are mutually parallel. The embodiment C of the construction component 1 is utilized when it is desired to end the composite wood arrangement in an even structural surface. In such an embodiment, the side surface 2 is profiled while the side surface 3 has an essentially even shape.

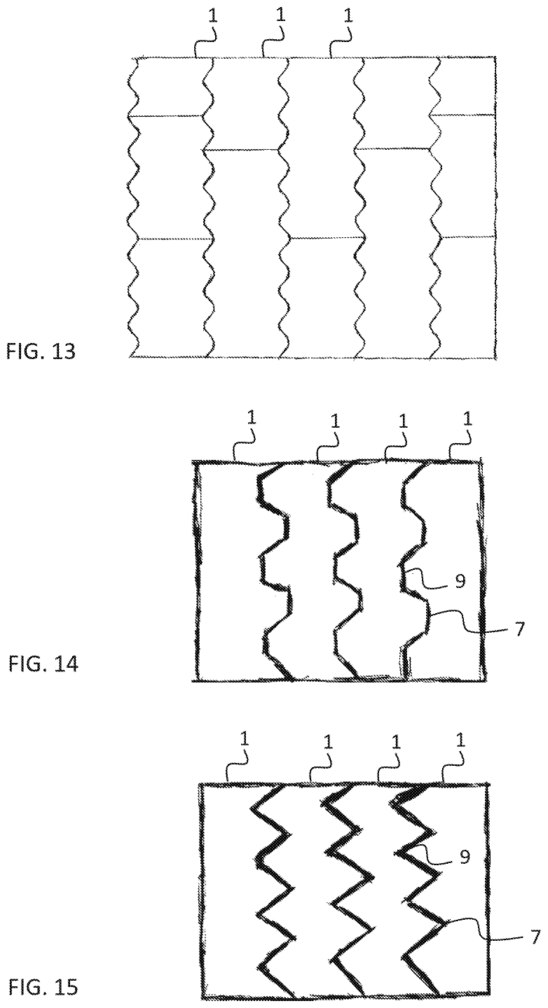

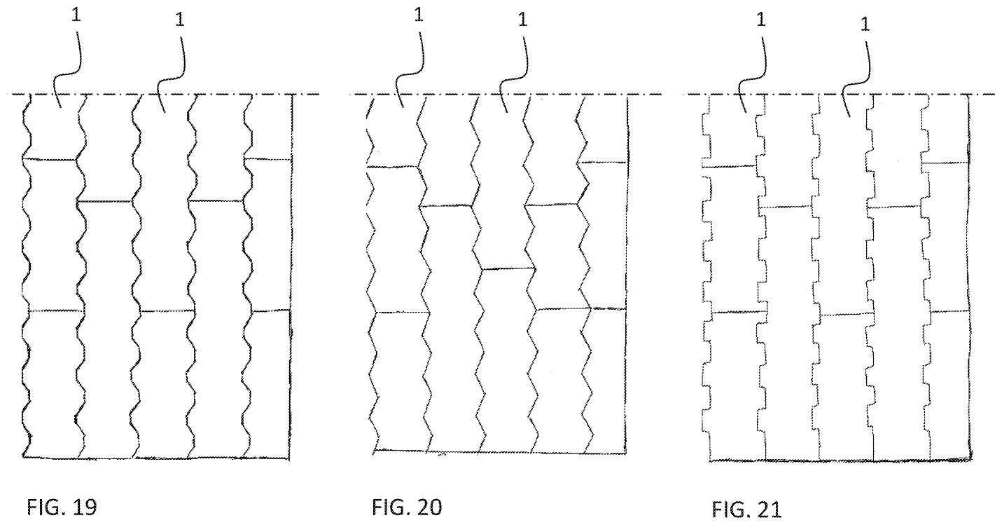

When construction components 1 are pressed against each other as in FIGS. 13 to 21, the construction components having the profiled side surfaces 2 and 3 are guided to overlap in relation to each other so that the profile crests 8 of a previous construction component settle at the profile troughs 9 of the corresponding subsequent construction component and vice versa, which establishes the tight joint face that is shown in the figures. When the construction component is made of wood, the height H of the profile in FIG. 2 is advantageously chosen so that it extends through a plurality of annual growth layers of the machined piece of wood, making the joint between the construction components stronger. In this embodiment, the length L of the profile is in turn advantageously substantially larger than the total thickness D of the construction component, being easy to machine strong enough and furthering the setting of the wooden battens in an opposite position, cf. FIG. 2.

By choosing such a profiled shape for the side surfaces 2 and 3 of the construction component 1, a considerably large contact surface between the construction components is achieved, which significantly increases the strength and load-bearing capacity of the structure. The seam structure created between the construction components with the technology of the type described, stiffens the structure formed of it against bending and warping, whereby the plate-like structure created with it remains straight and planar in all circumstances. At the same time, the shape of the construction components essentially facilitates the assembly of the final structure, because the construction components easily settle in place against each other. One of the remarkable advantages of a structure assembled out of such construction components made of wood is that when a regular wavelike structure is chosen for the profiling, it in a way tightens itself regardless of humidity conditions. When even a smallest gap is developed between adjacent battens, the battens slide due to the opposite waveforms slightly further apart from each other, causing a pressure against the structures that hold the construction component group together. Such a wavelike profile may be formed of a regular waveform known per se, such as a sinewave form in which the wave crests and wave troughs have been made parallel to the longitudinal axis of the construction component. The mutual locking of the construction components may further be enhanced by making the profile wavelike in two crossing directions. In such a case, then, the wave crests and troughs of the profile have been made both transverse in relation to the longitudinal axis of the construction component and following this waveform in the longitudinal direction of the construction component, as shown in FIG. 4.

When another form than the waveform shown in FIG. 2, for example, is selected for the profiling, an effective locking to each other of the construction components, in particular, is in turn achieved for the composite wood arrangement.

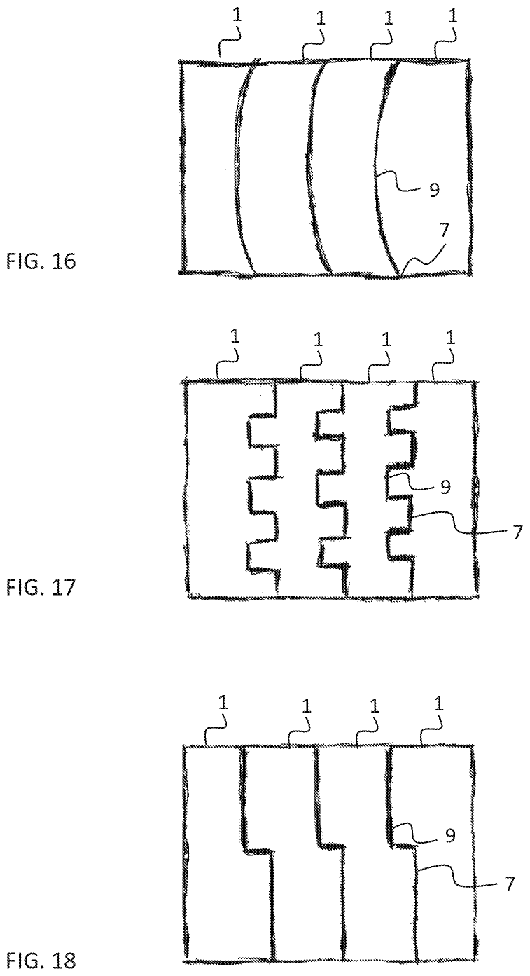

FIGS. 14 to 18 show alternative profiling achievable for the side surfaces and/or edge surfaces and/or end surfaces of the construction component. FIG. 14 hence shows a fraction line like profiling, FIG. 15 shows a zigzag-like profiling, FIG. 16 shows a uniform arc, FIG. 17 shows a continuous toothing, and FIG. 18 shows a profile created with a level difference.

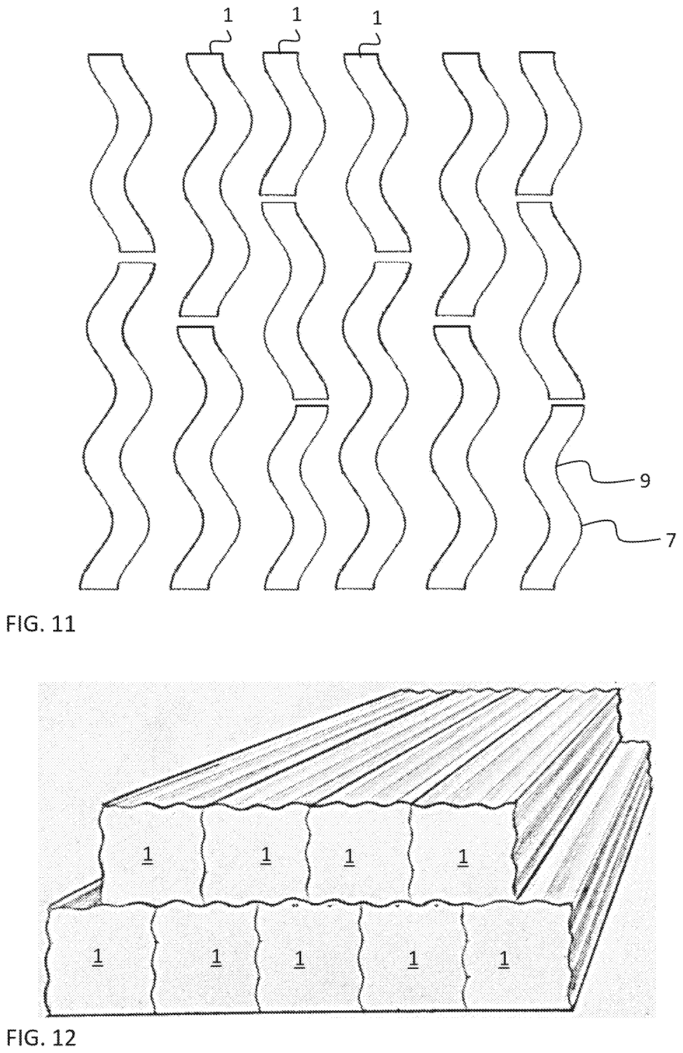

The present composite wood arrangement is formed in accordance with FIG. 10 or 11, for example, by adapting construction components 1 side by side. In such a case, the construction components may be joined together with a mechanical joint, such as a nail or screw. It is, however, more advantageous to join together more than one construction component at a time. For this purpose, one or more holes 10 have been drilled to the side surfaces 2 and 3, advantageously in advance, as shown in FIGS. 2 and 3, in a direction perpendicular to the longitudinal axis 11 of the construction component. Obviously, there is nothing to prevent making the holes at the same time as the construction components are adapted side by side, but holes made in advance significantly help the completion of the composite wood arrangement.

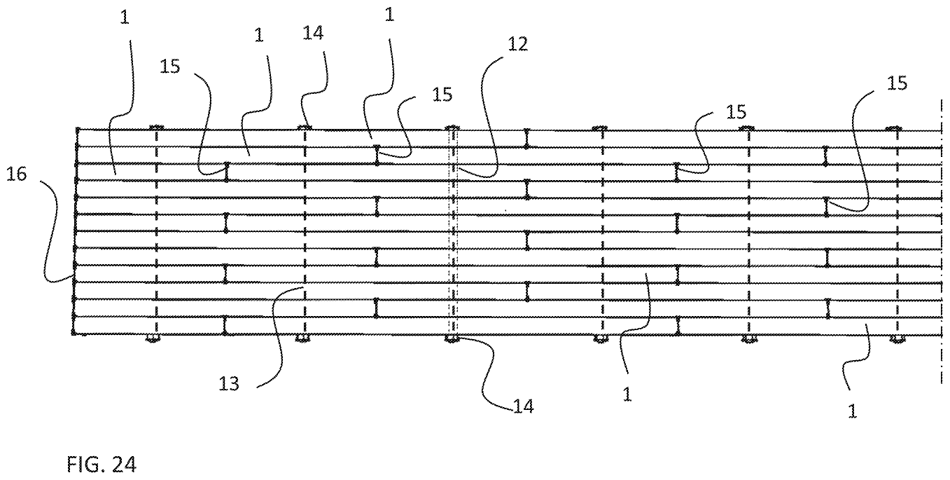

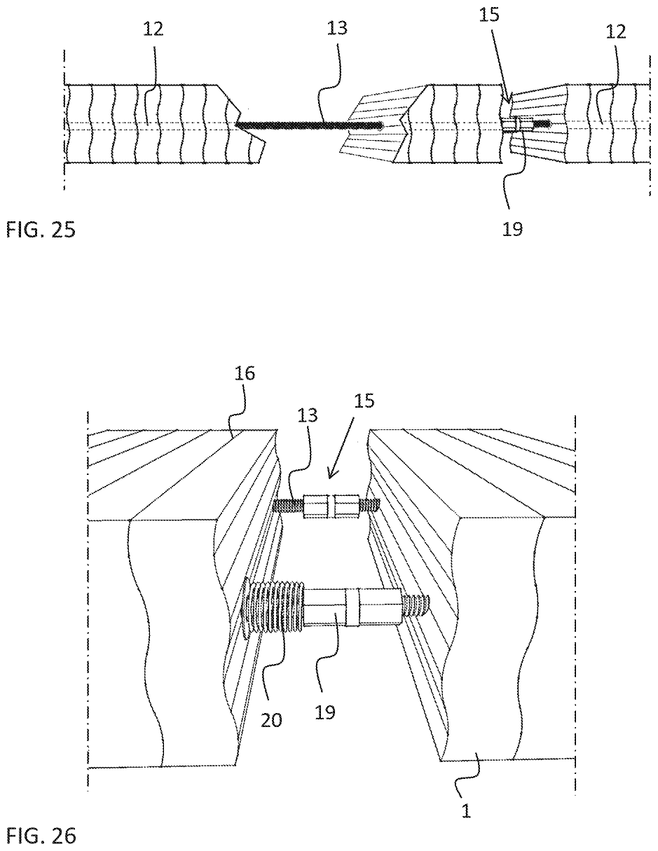

When the construction components 1 are located side by side, the holes 10 in them form a tightening channel 12 between opposite outer edges of the substantially uniform composite wood arrangement, outlined in FIG. 24, to which a drawbar 13, for example, may be adapted, such as a threaded bar known per se. The drawbar is equipped at its outer ends with bolts or other prevention means 14, which prevent the drawbar from exiting the tightening channel. Instead of a drawbar, other means establishing a tensile stress known per se may obviously be used, such as a metal or composite wire.

The composite wood arrangement advantageously also comprises at regular intervals such prevention means 14 adapted to the means 13 creating tensile stress, to tighten construction components 1 to each other also elsewhere than at their ends, only. Like this, the construction components press tightly against each other at a regular bases, forming a tight structure impenetrable by an airstream while at the same time large, uniform plate-like structures may be formed.

The thickness of the construction component 1, measured between the edge surfaces 4 and 5, may vary as may its width, measured between the side surfaces 2 and 3. The linear measure between the end surfaces 6 and 7 of the construction component may be selected as needed, although it is advantageous to allow the lengths of the longer construction components to be integer multiples of the shortest construction component when construction components of different lengths are used.

FIGS. 1 and 5 to 9 show some preferred embodiments of the construction component 1. FIG. 1 shows an elongated construction component where the end surfaces 6 and 7 as well as the edge surfaces 4 and 5 are significantly narrower than the side surfaces 2 and 3. Such a construction component may be so implemented that it is essentially straight in the direction of its longitudinal axis 11, or alternatively curved, either in the direction of its edge surfaces or side surfaces. In this embodiment, the profiling, too, has been created on said side surfaces, only.

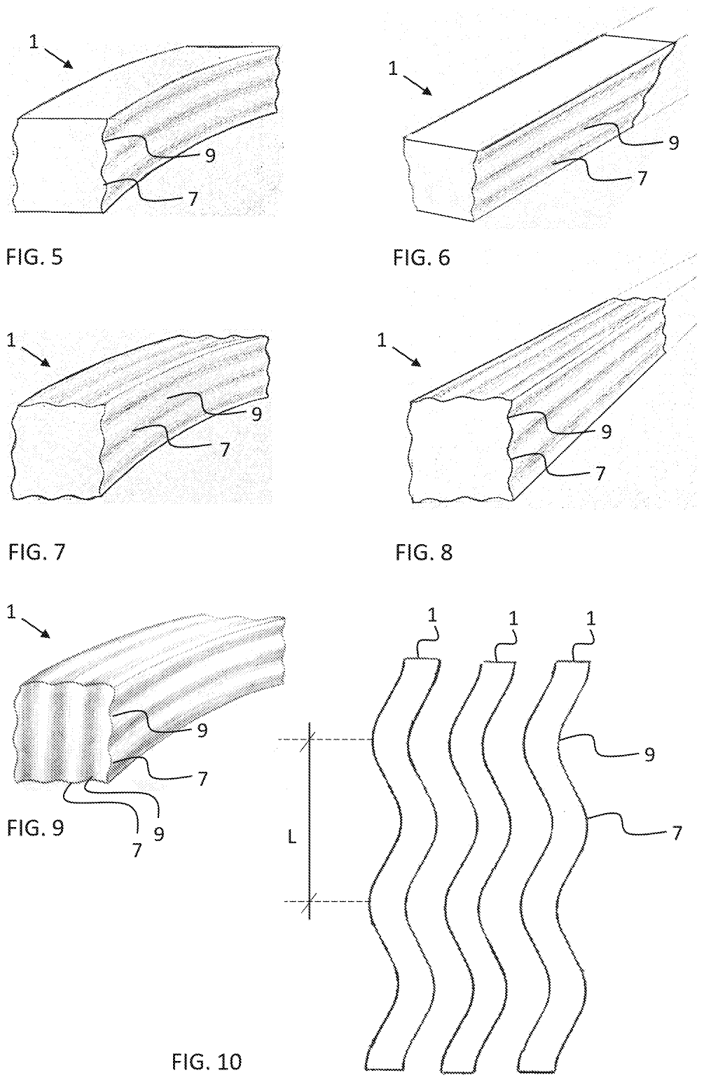

FIGS. 5 and 7 to 9 show construction components 1 whose side surfaces 2 and 3 as well as edge surfaces 4 and 5 are substantially of the same width. Such construction components may be essentially straight in the direction of their longitudinal axes, or alternatively curved, either in the direction of their edge surfaces or side surfaces. In the embodiment of FIG. 5, the profiling of the construction component is accomplished on the side surfaces, only, whereas FIGS. 7 and 8 show embodiments that have a profiling on both the side and edge surfaces. In the embodiment of FIG. 9, there is a profiling on the end surfaces 6 and 7, too. The cross section perpendicular to the longitudinal axis of a construction component according to FIG. 6 has the shape of a cut pyramid, whereby the structure is suitable for manufacturing various arched structures, for example. In such a case, the degree of narrowing of the construction component is regulated by the radius of the arched structure. The figure shows a construction component profiled on its side surfaces, only, but this, too, may comprise a profiling both on the side and edge surfaces as well as on the end surfaces.

The required thickness for the composite wood arrangement is achieved by choosing the most suitable construction component 1 as regards the length of its side surface, as in FIGS. 10 and 14 to 18, or by also installing the required number of construction components adjacently by their edge surfaces, as FIGS. 11 to 13 and 19 to 21 show. When joining together construction components in the direction of their length, width, and thickness, it is advantageous to select construction components that have a profiling on the side and edge surfaces, at least. When the designed structural thickness is reached, the outmost construction component may be selected to have a flat side surface, cf. FIG. 1C.

The present composite wood arrangement is very inexpensive also from the material technical aspect. It may thus be noted when examining FIG. 24 that the dimension construction components 1 in the structure are in the present solution installable successively in their longitudinal direction in a simple manner and side by side in the lateral direction of the structure to create a uniform plate-like structure. In this case, the construction components have been installed so that the joints 15 of successive construction components, seen in the figure, never fall adjacently in a completed structure, but there is always at least one or more solid construction components passing the joint between adjacent construction components. Due to the support provided by the profiled construction component, adjacent construction components rest on the profiled shapes of each other, thus forming a part of a working static system. This results in a stiff structure capable of handling large loads, even if all the individual construction components would not reach the support of the structure. The forms of the construction components also allow the extending of the construction component in a random spot due to, in particular, the support that the profiling gives.

For example as in FIG. 1, there may be one or more different construction components 1 by their width between the edge surfaces 4 and 5. The width of the construction component is chosen so that they are advantageously integer multiples of the wavelength L, that is, the profile length.

The desired composite wood arrangement is formed out of construction components 1 so that the end forming the end 16 of the arrangement comprises construction components placed side by side and increasing in length, or as shown in FIG. 14, shortening in length. In other words, the construction components are arranged lengthwise successively either in an ascending or descending order. Alternatively, the construction components may be lengthwise in an ascending and descending order in an alternating fashion. The opposite end of the composite wood arrangement is formed in the same way, if possible, of construction components of varying lengths. If a suitable length for the arrangement cannot be achieved in this manner, the structure may naturally be cut at the desired point. The other construction components of the composite wood arrangement are advantageously all long. This way it is possible to accomplish fast a composite wood arrangement to be used for building a house 17, for example, in which the construction components are advantageously vertically oriented when a wall 18, for example, is being built. In this respect, the structure may be compared to a traditional vertical log wall, the present invention however proving a far better end product as regards thermal values, strength and tightness.

The composite wood arrangement may be formed to be substantially continuous width-wise as described in the above, whereby the construction components 1 are tightened to each other by the prevention means 14 installed at regular intervals in the means 13 that create tensile stress. Said means creating tensile stress are connected together in their longitudinal direction by extension sleeves 19 to lengthen them through all the adjacently arranged construction components. This forms a uniform surface structure that is immediately ready for use, if desired. By installing spring member 20 between the prevention means or extension sleeve and the construction component, the transverse expansion taking place in the construction component group may also be taken into account. In such a case, a small expansion margin is left between adjacent groups at desired intervals, for example every two metres, by which a controlled humidity behaviour of the structure is ensured.

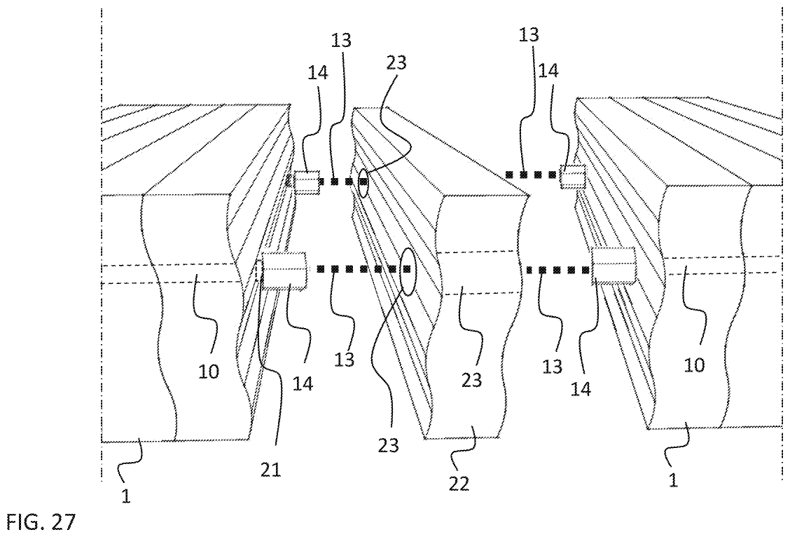

FIG. 27 shows a method for manufacturing complete construction components by making use of the present composite wood arrangement. Thus, elements having a standard width and length may be formed, in which the construction components 1 are tightened to each other by means of installation tubes 21 adapted in the holes 10 formed in a direction perpendicular to the longitudinal axis 11 of the construction components. Such installation tubes are advantageously made of metal, such as stainless steel. The installation tubes protrude from the hole 10 in the construction component to such an extent that prevention means 14, such as a bolt, may be installed at its opposite ends, to tighten the construction components to each other. These elements may in turn be installed side by side, whereby between them a specific installation component 22 is adapted, which has prevention means channels 23 to receive the prevention means. Once the designed elements have been installed in place, the means 13 creating a tension stress are led through the installation tubes. With the means 13, an element group is compiled into a uniform board by second prevention means 14 installed on the outer edges of the element group.

Regardless of the structure to be manufactured, the significant advantage of the present solution is the simple joining technology of the construction component 1 and the easy handling brought about by its small physical dimensions. On the other hand, the compiling of the composite wood arrangement without specific fixing devices or glues makes it even possible to dismantle the structure and move it to a new usage site.

A person skilled in the art will find it obvious that, as technology advances, the basic idea of the invention may be implemented in many different ways. The invention and its embodiments are thus not restricted to the above-described examples but may vary within the scope of the claims.

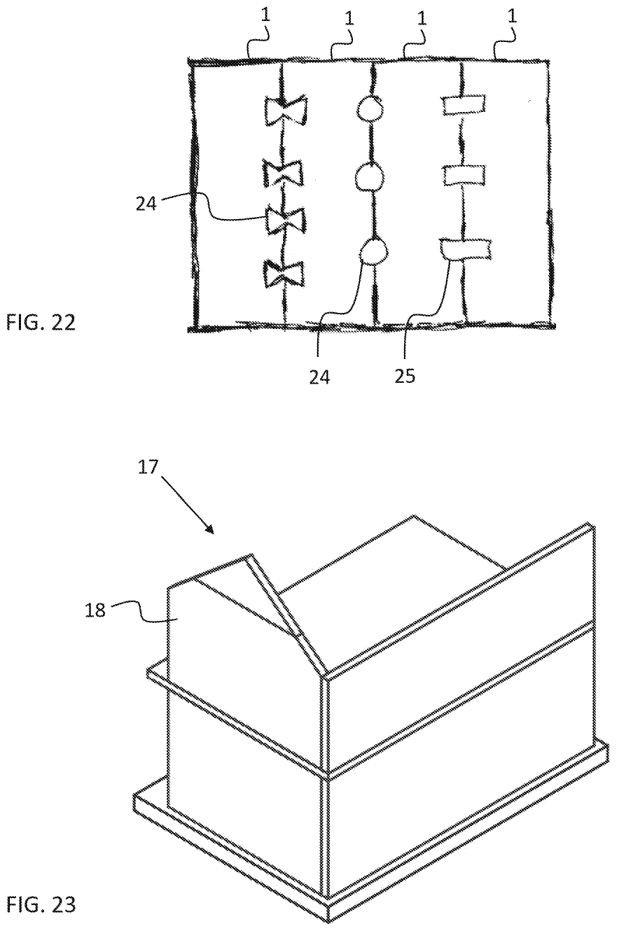

It is therefore possible to manufacture a composite wood arrangement of the type being discussed by replacing the profiling of the side surfaces 2 and 3 of the construction component 1 by separate joining strips 24 or pegs 25 as shown in FIG. 22.

1. A composite wood arrangement comprising:
a plurality of construction components (1) mechanically joined together in a parallel position so that
each construction component comprises at least one profiled side surface (2, 3),
said side surface having a regular wavelike structure, said side surface comprising edge surfaces and end surfaces (6, 7), perpendicular to the longitudinal axis (11) of the construction component connecting the side surfaces together,
the wavelike structure having wave crests (8) and wave troughs (9) being parallel to each other and to the longitudinal axis (11) of the construction component (1),
the construction components being adapted in an opposite position in pairs,
characterised in that
the construction components (1) are adapted successively in their longitudinal direction and adjacently in at least the lateral directions of the composite wood arrangement to establish a uniform structure, whereby
the construction component may have one or several different thicknesses measured between the edge surfaces (4, 5),
the thickness of the construction component being chosen so that they are integer multiples of the wavelength (L) of the profile.

2. A composite wood arrangement as claimed in claim 1, characterised in that the construction component (1) is elongated so that in a cross-section perpendicular to its longitudinal direction the edge surfaces (4, 5) are considerably narrower than the side surfaces (2, 3).

3. A composite wood arrangement as claimed in claim 1, characterised in that side surfaces (2, 3) and edge surfaces (4, 5) of the construction component (1) are in a cross-section perpendicular to its longitudinal direction substantially of the same width.

4. A composite wood arrangement as claimed in any one of the preceding claims, characterised in that the construction component (1) is, in the direction of its longitudinal axis (11), curved in the direction of its edge surfaces (4, 5).

5. A composite wood arrangement as claimed in any one of claims 1 to 3, characterised in that the construction component (1) is, in the direction of its longitudinal axis (11), curved in the direction of its side surfaces (2, 3).

6. A composite wood arrangement as claimed in any one of claims 1 to 3, characterised in that each construction component (1) comprises at least one profiled side surface (2, 3), at least one profiled edge surface (4, 5), and at least one profiled end surface (6, 7).

7. A composite wood arrangement as claimed in any one of claims 1 to 3, characterised in that the profiling comprises a wavelike form whose wave crests and wave troughs are parallel to the longitudinal axis of the construction component.

8. A composite wood arrangement as claimed in any one of claims 1 to 3, characterised in that the profiling comprises a wavelike form whose wave crests and wave troughs are parallel to both the direction of the longitudinal axis of the construction component and transverse in relation to it.

9. A composite wood arrangement as claimed in any one of claims 1 to 3, characterised in that there are at least two construction components (1) side by side in both the lateral direction and thickness direction of the composite wood arrangement.

10. A method for manufacturing a composite wood arrangement, wherein
construction components (1) are formed, which comprise at least one profiled side surface (2, 3) having a regular wavelike structure and, connecting them together, edge surfaces (4, 5) and end surfaces (6, 7), perpendicular to the longitudinal axis (11) of the construction component, and
said construction components (1) are installed in a parallel position in relation to each other, such that
the parallel construction components are adapted in an opposite position in pairs so that wavelike profile crests (8) and troughs (9) in opposite surfaces are substantially parallel,
characterised in that
the construction components (1) are adapted successively in their longitudinal direction and adjacently in the lateral directions of the composite wood arrangement, establishing a uniform structure, hereby
choosing the construction components of one or several different thicknesses measured between the edge surfaces (4, 5), and
choosing the construction components such that the thickness thereof are integer multiples of the wavelength (L) of the profile.

11. A method as claimed in claim 10, characterised in that construction components (1) are joined together in both the lateral direction and thickness direction of the composite wood arrangement so that
there are at least two of them side by side.

12. A method as claimed in claim 10 or 11, characterised by forming at least one hole (10) in the construction component (1) between the side surfaces and substantially perpendicular to the longitudinal axis (11) of the construction component, to form a tightening channel (12) to which
tightening channel a drawbar (13) with its prevention means (14) and extending to the outer edges of the composite wood arrangement may be led to tighten the construction components penetrated by the drawbar against each other.

13. A method as claimed in any one of claim 10 or 11, characterised in that in a composite wood arrangement consisting of construction components (1) arranged side by side, the construction components are installed successively in the direction of their longitudinal axes (11) so that between the joints (15) of adjacent construction components there is always at least one solid construction component passing the joint.

14. A method as claimed in any one of claim 10 or 11, characterised in that construction components (1) are grouped at the end (16) of the composite wood arrangement either in an ascending or descending order of length.
